(19) United States
(12) Patent Application Publication
(10) Pub. No.: US 2003/0016939 A1
(43) Pub. Date: Jan. 23, 2003

(54) Apparatus and method for searching for broadcast signal using a storage medium in a TV

(75) Inventor: Kyong-il Yun, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/084,486

(22) Filed: Feb. 28, 2002

(30) Foreign Application Priority Data
Jul. 21, 2001 (KR) 2001-44061

(51) Int. Cl. H04N 9/79

(52) U.S. Cl. 386/5

(57) ABSTRACT

An apparatus and method for searching for a broadcast signal in a TV, in which broadcast TV programs are stored in real time using a storage medium and TV programs recorded in the storage medium are quickly searched for, are provided. According to the apparatus and method, by embedding a storage medium in a TV, a broadcast signal of a TV program the user is watching is stored in real time, and by controlling the storage medium, a TV program broadcast at a desired time before the current time, which the user watched, can be quickly and accurately searched for. Also, high speed search and slow search functions are enabled.

### BACKGROUND OF THE INVENTION

1. Field of the Invention

The present invention relates to an apparatus and method for searching for a broadcast signal of a television (TV), and more particularly, to an apparatus and method for searching for a broadcast signal in a TV, in which broadcast TV programs are stored in real time using a storage medium and TV programs recorded in the storage medium are quickly searched for. The present application is based on Korean Patent Application No. 2001-44061 filed on Jul. 21, 2001, which is incorporated herein by reference.

2. Description of the Related Art

In real time, a TV processes a broadcast signal, which a TV broadcasting station transmits, and outputs the TV program through the cathode ray tube and speaker. Thus, a recording apparatus such as a Video Cassette Recorder (VCR) is connected to the TV and stores the TV program. However, due to the limit of the storage capacity of a recording medium in the VCR, only needed TV programs are selectively recorded. Besides, the VCR should be connected to the TV for recording. In addition, recorded TV programs cannot be quickly searched for, and a broadcast TV program which was broadcast at a predetermined time before the current time cannot be accurately searched for.

### SUMMARY OF THE INVENTION

To solve the above problems, it is an objective of the present invention to provide an apparatus and method for searching for a broadcast signal using storage media in a TV, in which by embedding storage media in the TV, broadcast TV programs are recorded in real time and the locations of recorded TV programs are quickly and accurately searched for.

To accomplish the objective of the present invention, there is provided an apparatus for searching for broadcast signals in a television (TV) including a storing means for storing a broadcast signal, which is received from the TV, in real time; a skip control unit for skip-sampling the broadcast signal stored in the storing means, based on a set multiple-times speed; and a direct move (DM) control unit for searching the broadcast signal stored in the storing means for the location of a frame corresponding to a set time point.

Also to accomplish the objective of the present invention, there is provided a method for backward searching for a broadcast signal in a method for searching for a broadcast signal using a storage medium of a TV, the method including the steps of (a) determining whether or not a Direct Move (DM) key is input; (b) setting a time point to be searched for if the DM key is input; (c) calculating a distance value (Ptemp) from a current address pointer value corresponding to the time set in step (b); (d) calculating the difference (Pd) between the current address pointer value (Pnow) and the distance value (Ptemp) calculated in step (c); (e) comparing the value (Pd) with the minimum value (Pmin) of the address pointers of the storing means; and (f) determining the value (Pd) as the address pointer value of a location which is searched for if the comparison result of step (e) indicates that the value (Pd) is equal to or greater than the minimum value (Pmin), and otherwise, determining a value, which is obtained by subtracting the minimum value (Pmin) from the value (Pd) and adding the subtraction result to the maximum value (Pmax) of address pointers of the storing means plus 1, as the address pointer value of the location which is searched for.

Also to accomplish the objective of the present invention, there is provided a method for forward searching for a broadcast signal in a method for searching for a broadcast signal using a storage medium of a TV, the method including the steps of (a) determining whether or not a Direct Move (DM) key is input; (b) setting a time point to be searched for if the DM key is input; (c) calculating a distance value (Ptemp) from a current address pointer value corresponding to the time set in step (b); (d) calculating the sum (Pd) of the current address pointer value (Pnow) and the distance value (Ptemp) calculated in step (a); (e) comparing the value (Pd) with the maximum value (Pmax) of the address pointers of the storing means; and (f) determining the value (Pd) as the address pointer value of a location which is searched for if the comparison result of step (e) indicates that the value (Pd) is not greater than the maximum value (Pmax), and otherwise, determining a value, which is obtained by subtracting the maximum value (Pmax) of address pointers of the storing means plus 1 from the value (Pd), as the address pointer value of the location which is searched for.

### BRIEF DESCRIPTION OF THE DRAWINGS

The above objects and advantages of the present invention will become more apparent by describing in detail preferred embodiments thereof with reference to the attached drawings in which:

FIG. 1 is a diagram of the structure of an apparatus for searching for a broadcast signal using a storage medium in a TV according to the present invention;

FIG. 2 is a flowchart of a method for backward searching for a broadcast signal using a storage medium in a TV according to the present invention;

FIGS. 3(a) and 3(b) are diagrams of the structures of a first Moving Picture Experts Group (MPEG) video stream and video frames recorded in a storage medium applied to the present invention;

FIGS. 4(a) and 4(b) are diagrams of the structures of a second MPEG video stream and video frames recorded in a storage medium applied to the present invention;

FIG. 5 is a detailed diagram of a search control unit of FIG. 1;

FIG. 6 is a flowchart of a method for forward searching for a broadcast signal using a storage medium in a TV according to the present invention;

FIGS. 7(a) and 7(b) are diagrams of major address pointer values of the storage medium for explaining the method for backward searching for a broadcast signal stored in the storage medium of FIG. 2; and

FIGS. 8(a) and 8(b) are diagrams of major address pointer values of the storage medium for explaining the method for forward searching for a broadcast signal stored in the storage medium of FIG. 6.

### DESCRIPTION OF THE PREFERRED EMBODIMENTS

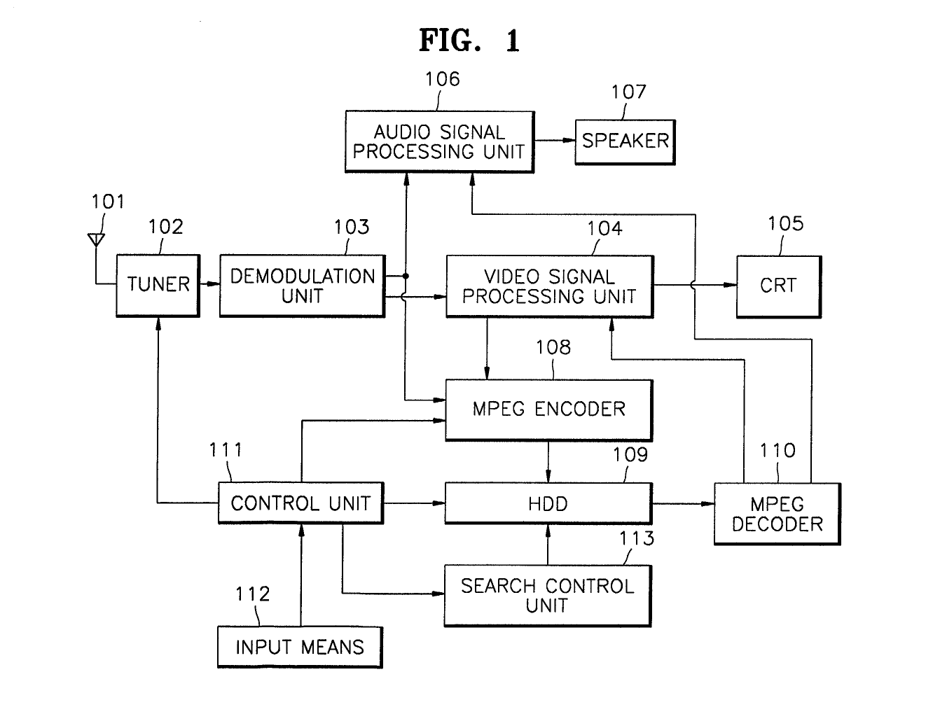

As shown in FIG. 1, an apparatus for searching for a broadcast signal using a storage medium in a TV according to the present invention includes an antenna 101, a tuner 102, a demodulation unit 103, a video signal processing unit 104, a Cathode Ray Tube (CRT) 105, an audio amplifier 106, a speaker 107, a Moving Picture Experts Group (MPEG) encoder 108, a Hard Disc Drive (HDD) 109, an MPEG decoder 110, a control unit 111, an input means 112 and a search control unit 113.

The basic operation of a TV will now be briefly explained.

After a user turns on the power of the TV by a key button of the input means 112 such as a remote controller, and selects a desired channel, the tuner 102 selects only the broadcast signal of a channel selected by the user among broadcast signals received through the antenna 101. Then, the demodulation unit 103 detects a video signal and an audio signal in the broadcast signal of the selected channel, divides the signals, and outputs the video signal and the audio signal to the video signal processing unit 104 and the audio signal processing unit 106, respectively. Then, the audio signal input to the audio signal processing unit 106 is amplified to an audio volume value set by the user. After performing signal processing, for example, filtering, the audio signal is output through the speaker 107. The video signal processing unit 104 converts the input video signal to a signal appropriate for the Cathode-Ray Tube (CRT) 105 and outputs the converted signal through the CRT 105.

Next, the operation of searching for a broadcast signal according to the present invention will now be explained.

The broadcast signal received through the antenna 101 is output in real time through the CRT 105, and is encoded by the MPEG encoder 108, then stored in real time in the storage medium, the HDD 109. The HDD 109 is designed to record the broadcast signal in units of a predetermined sequential and cyclical time period in real time. That is, the HDD 109 is designed so that after a broadcast signal is recorded for a predetermined amount of time, the broadcast signal recorded in the HDD 109 is sequentially erased in order of recording and at the same time a broadcast signal is recorded in real time. Also, data is cyclically recorded on the HDD 109 and overwriting data on a part on which previous data is recorded causes damage to a header part so that the entire file cannot be read. Therefore, the broadcast signal is recorded in units of the predetermined time period.

If in order to search a TV program which the user watched a predetermined time before, the user inputs a direct move (DM) key and sets a time desired to be searched for, the control unit 111 applies the DM command and the set time information, which is calculated in terms of seconds, to the search control unit 113.

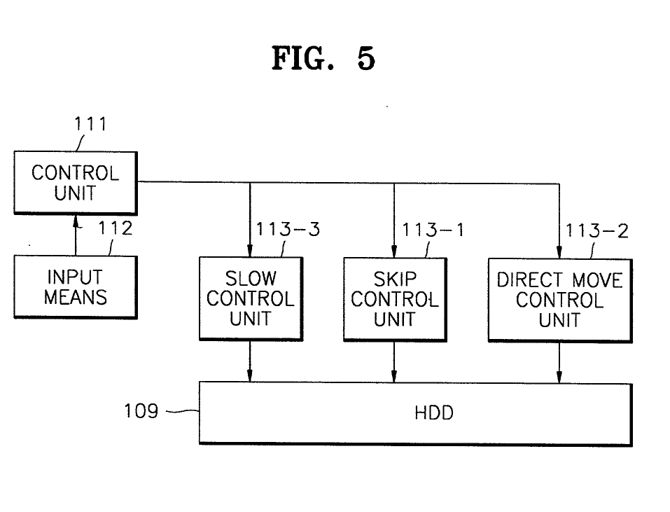

As shown in FIG. 5, the search control unit 113 includes a slow control unit 113-3, a skip control unit 113-1, and a DM control unit 113-2. The DM command and time information are input to the DM control unit 113-2.

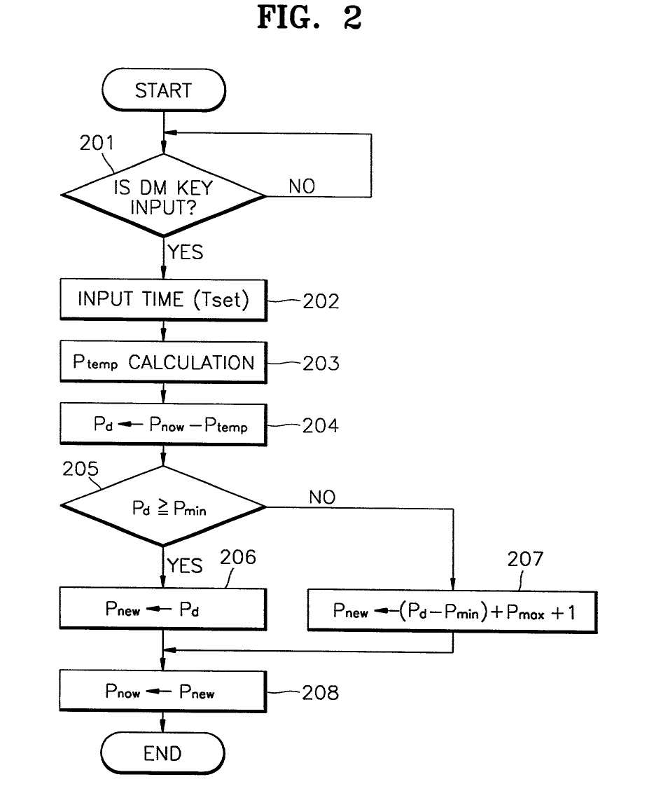

Then, according to an algorithm, as shown in the flowchart of FIG. 2, at the present time point the DM control unit 113-2 quickly and accurately searches for a TV program recorded on the HDD 109 in the past.

That is, if time information is input after the DM key is input, the DM control unit 113-2 performs the following algorithm in steps 201 and 202, as described above.

Before explaining the algorithm according to the present invention, the structure of an MPEG video stream and the structure of a memory will now be explained.

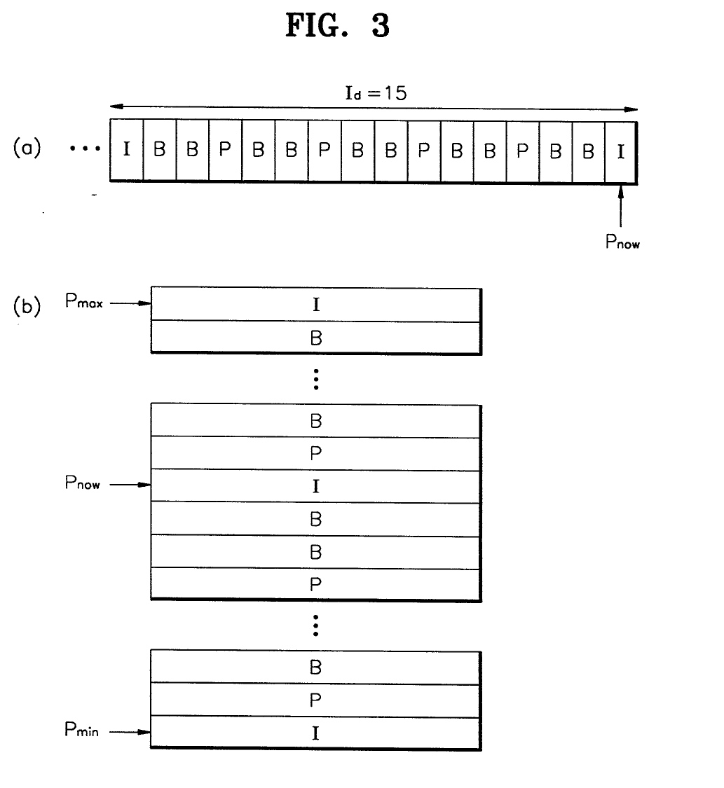

FIG. 3(a) is a diagram of an MPEG video stream.

In the MPEG standards, picture frames are divided into three types, I frames, P frames, and B frames. An I frame is encoded by its own information and is generated without prediction between frames. A P frame is generated by forward prediction between frames at an I frame or at a P frame. A B frame is generated by bidirectional prediction of neighboring two frames. In a video stream which is output to the screen through the MPEG decoder, frames are output in order of I B B P B B P B . . . frames, as shown in FIG. 3(a).

MPEG video frames, which are recorded in the storage media by the MPEG encoder, are recorded in order of I P B B P B B P . . . frames, as shown in FIG. 3(b). FIG. 3(b) is a diagram of a video signal recorded in the storage medium, in which each frame is given an address. Here, Pmin denotes the minimum value of the addresses of the storage medium, Pmax denotes the maximum value of the addresses of the storage medium, and Pnow denotes the current address value of the storage medium.

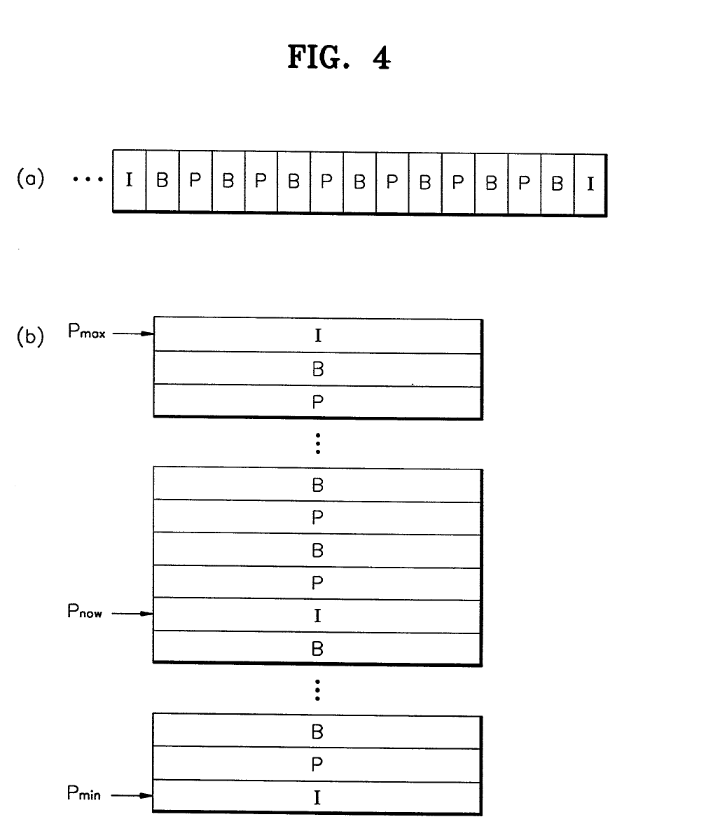

FIGS. 4(a) and 4(b) are diagrams of another type of MPEG video stream specification and a memory storing structure, which is characterized in that one B frame, instead of two B frames, is inserted between I or P frames.

In the storage medium, frame data of a video signal is recorded from a location of the minimum address to a location of the maximum address. If frame data is recorded to the location of the maximum address, frame data is overwritten on frame data recorded from on the location of the minimum address. Thus, frame data is continuously recorded. That is, the HDD 109 records broadcast signals cyclically and continuously in real time.

First, a frame distance value (Ptemp) of a time input in step 202 is calculated from the current frame in step 203. Here, the location of the current frame corresponds to the location of an I frame. If the location of the current frame is not the location of an I frame, the frame distance value (Ptemp) is calculated after an I frame arrives.

The frame distance value (Ptemp) from the current frame is calculated by equation 1:

$$P t emp = \frac{( T s e t ) * S r}{I d - 1} \qquad ( 1 )$$

Here, Tset denotes an input time point calculated in terms of seconds,

Sr denotes a scan rate, and Id denotes the interval between I frames.

Then, the difference (Pd) between the current storage medium address pointer value (Pnow) and the distance value (Ptemp) calculated in step 203 is calculated in step 204.

Next, the calculated value (Pd) is compared with the minimum value (Pmin) of storage medium address pointers in step 205. The comparison of the calculated value (Pd) with the minimum value (Pmin) of storage medium address pointers of the HDD 109 is to determine whether or not the difference (Pd) exceeds the minimum value (Pmin) of the storage medium addresses and to prevent the occurrence of underflow in skipping from the current frame location to a desired frame.

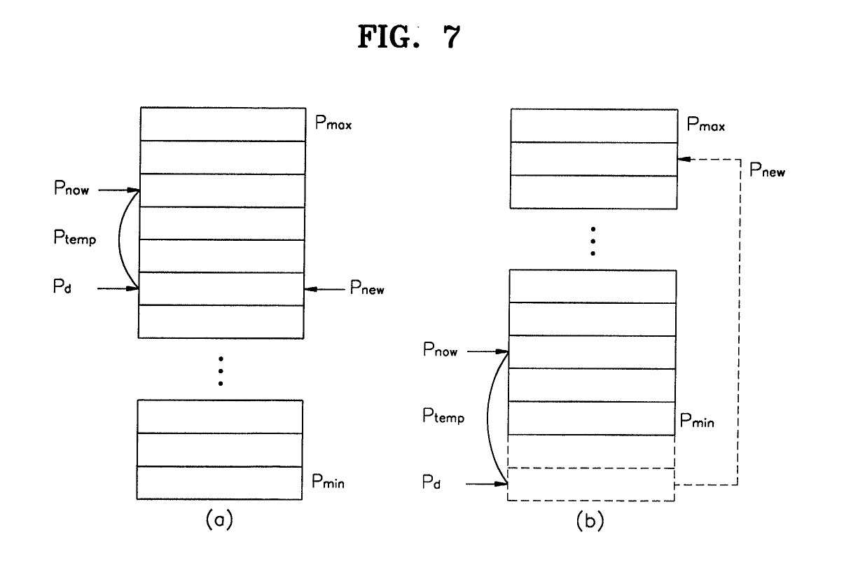

If the determination result of step 205 indicates that the calculated value (Pd) is equal to or greater than the minimum value (Pmin) of the storage medium address pointers of the HDD 109, the address pointer value corresponding to a desired location does not exceed the minimum address value of the storage medium as shown in FIG. 7(a). In this case, the new value of a new storage medium address pointer corresponding to the desired location is set to the calculated value (Pd) in steps 206 and 208.

However, if the determination result of step 205 indicates that the calculated value (Pd) is less than the minimum value (Pmin) of the storage medium address pointers, the address pointer value corresponding to the desired location exceeds the minimum address value of frames as shown in FIG. 7(b). In this case, the new storage medium address pointer value is set to a value which is obtained by applying the exceeding amount below the frame minimum address value to the maximum address value. That is, the storage medium address pointer value (Pnew) corresponding to the desired location is calculated by the following equation 2 in step 207:

Pnew=(Pd−Pmin)+Pmax+1 . . . (2)

Then, the storage medium address pointer value corresponding to the desired location, which is obtained in step 207, is applied in step 208.

By doing so, the DM mode changes the current storage medium address pointer value to a storage medium address pointer value for movement to a desired frame corresponding to the set time point so that a TV program at the time point which the user desires to search for is reproduced.

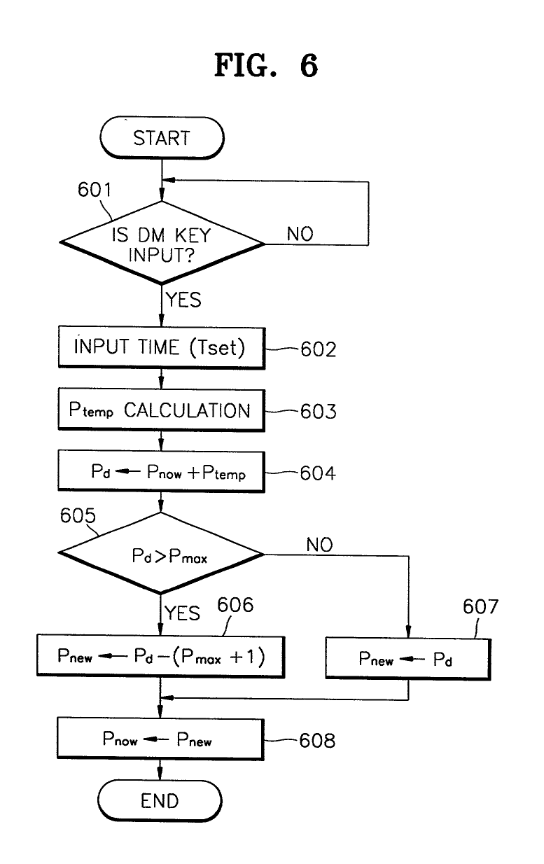

FIG. 6 is a flowchart of an algorithm for forward searching for a broadcast signal at the current time point in a process for reproducing the past scenes using a storage medium.

That is, FIG. 2 shows the algorithm for backward searching while FIG. 6 shows the algorithm for forward searching.

Therefore, steps 601-603 are the same as steps 201-203 of FIG. 2, and the sum (Pd) of the current storage medium address pointer value (Pnow) and the distance value (Ptemp) calculated in step 203 is calculated in step 604.

Then, the calculated value (Pd) is compared with the maximum value (Pmax) of the storage medium address pointers of the HDD 109 in step 605.

The comparison of the calculated value (Pd) with the maximum value (Pmax) of storage medium address pointers of the HDD 109 is to determine whether or not the difference (Pd) exceeds the maximum value (Pmax) of the storage medium addresses and to prevent the occurrence of overflow in skipping from the current frame location to a desired frame.

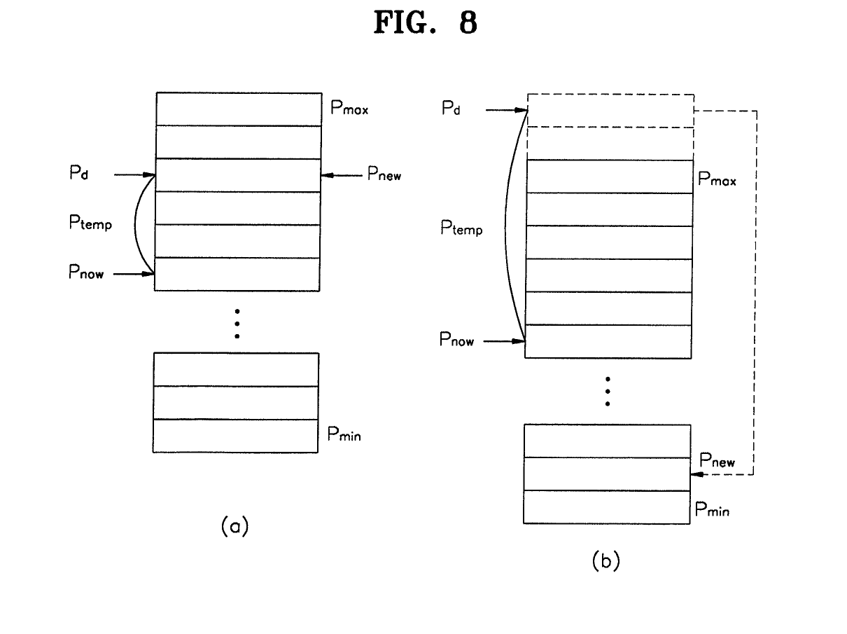

If the determination result of step 605 indicates that the calculated value (Pd) is equal to or less than the maximum value (Pmax) of the storage medium address pointers of the HDD 109, the address pointer value corresponding to a desired location does not exceed the maximum address value of the storage medium as shown in FIG. 8(a). In this case, the new value of a storage medium address pointer corresponding to the desired location is set to the calculated value (Pd) in steps 607 and 608.

However, if the determination result of step 605 indicates that the calculated value (Pd) is greater than the maximum value (Pmax) of the storage medium address pointers, the address pointer value corresponding to the desired location exceeds the maximum address value of the storage medium, as shown in FIG. 8(b). In this case, the new storage medium address pointer value is set to a value which is obtained by applying the exceeding amount over the storage medium maximum address value to the minimum address value. That is, the storage medium address pointer value (Pnew) corresponding to the desired location is calculated by the following equation 3 in step 606:

Pnew=Pd−(Pmax+1) . . . (3)

Then, the storage medium address pointer value, which corresponds to the desired location and is obtained in step 606, is applied in step 608.

Next, a reproduction search at multiple times speed will now be explained. If the user inputs a high multiple times speed search command by a key of the input means, the control unit 111 sends information on the input to the skip control unit 113-1. Then, the skip control unit 113-1 extracts frame data by skip-sampling frame information based on the set multiple times speed, and outputs the frame data to the MPEG decoder 110. For example, if 2 times speed search is selected and the current frame is an I or P frame in the MPEG decoded video stream as shown in FIG. 4(a), B frames are skipped from the current frame location and frame data is extracted in order of I PPPPP . . . . If the current frame is a B frame, then, after an I or P frame arrives, frame skip-sampling is performed. This is because a B frame needs bidirectional prediction, and if a neighboring frame is skipped, the B frame cannot be decoded.

Thus, in the MPEG video stream of FIG. 3(a), B frames can be skipped, so a search can be performed at speeds of multiples of 3 times the normal speed. Therefore, for example, if in the present invention, the distance (M) between an I frame and the following P frame is set to 2 and the distance between an I frame and the next I frame is designed to be a number which is a multiple of M, the speed of search may vary 2ⁿ times faster from a speed of 2 times speed to 64 times speed (here, n is an integer number).

As an example of an input means 112 for a multiple times speed search, a jog shuttle input means may be used so that the search speed can vary with respect to a rotation angle.

Next, a slow reproduction search will now be explained.

If the user inputs a slow search command by a key of the input means 112, the control unit 111 sends the input information to the slow control unit 113-3. Then, if the set speed is a 1/N times speed (N is an integer), the slow control unit 113-3 controls the HDD 109 so that the same frame is decoded and output N times repeatedly.

As described above, according to the present invention, by embedding a storage medium in a TV, a broadcast signal of a TV program the user is watching is stored in real time, and by controlling the storage medium, a broadcast TV program of a desired time before the current time, which the user watched, can be quickly and accurately searched for. Also, high speed search and slow search functions are enabled.

The present invention may be executed as a method, an apparatus, and a system. When executed in software, elements of the present invention are necessarily code segments performing needed jobs. Program or code segments may be stored in a processor readable medium, or may be transmitted in a computer data signal coupled with carrier waves in a transmission medium or telecommunications networks. The processor readable medium may be any medium which can store or transmit information. For example, the processor readable medium may be an electronic circuit, a semiconductor memory device, a read-only memory (ROM), a flash memory, an erasable read-only memory (EROM), a floppy disc, an optical disc, a hard disc drive, a fiber optic medium, a radio frequency network, etc. The computer data signal includes any signal that can be transmitted through a transmission medium such as electronic network channels, optical fiber, air, electronic fields, a radio frequency network, etc.

The present invention is not restricted to the above-described embodiments, and many variations are possible within the spirit and scope of the present invention. Therefore, the scope of the present invention is not determined by the description but by the accompanying claims.

What is claimed is

1. An apparatus for searching for broadcast signals in a television (TV) comprising:
a storage medium for storing a broadcast signal, which is received from the TV;
a skip control unit for skip-sampling the broadcast signal stored in the storage medium, based on a set multiple-times speed; and
a direct move (DM) control unit for searching the broadcast signal stored in the storage medium for the location of a frame corresponding to a set time point.

2. The apparatus of claim 1, wherein the storage medium is a Hard Disc Drive (HDD).

3. The apparatus of claim 1, wherein the storage medium stores the broadcast signal in real time.

4. The apparatus of claim 1, further comprising:
a slow control unit for reproducing one frame N times repeatedly if a slow multiple-times speed is set to 1/N (N is an integer).

5. The apparatus of claim 1, wherein the skip control unit samples frames by skipping frames based on a set multiple-times speed, starting from an I frame.

6. The apparatus of claim 1, wherein the DM control unit searches for a frame, by calculating the address pointer location value of a previous I frame, which corresponds to a set time, based on a current I frame, according to a predetermined algorithm.

7. The apparatus of claim 6, wherein a backward search algorithm of the predetermined algorithm comprises the steps of:
(a) calculating a distance value (Ptemp) from a current address pointer value (Pnow) corresponding to the set time;
(b) calculating the difference (Pd) between the current address pointer value (Pnow) and the distance value (Ptemp) calculated in step (a);
(c) comparing the value (Pd) with the minimum value (Pmin) of the address pointers of the storage medium; and
(d) determining the value (Pd) as the address pointer value of a location which is searched for if the comparison result of step (c) indicates that the value (Pd) is equal to or greater than the minimum value (Pmin), and otherwise, determining a value, which is obtained by subtracting the minimum value (Pmin) from the value (Pd) and adding the subtraction result to the maximum value (Pmax) of address pointers of the storage medium plus 1, as the address pointer value of the location which is searched for.

8. The apparatus of claim 6, wherein a forward search algorithm of the predetermined algorithm comprises the steps of:
(a) calculating a distance value (Ptemp) from a current address pointer value (Pnow) corresponding to the set time;
(b) calculating a sum (Pd) of the current address pointer value (Pnow) and the distance value (Ptemp) calculated in step (a);
(c) comparing the value (Pd) with a maximum value (Pmax) of the address pointers of the storage medium; and
(d) determining the value (Pd) as the address pointer value of a location which is searched for if the comparison result of step (c) indicates that the value (Pd) is not greater than the maximum value (Pmax), and otherwise, determining a value, which is obtained by subtracting the maximum value (Pmax) of address pointers of the storage medium plus 1 from the value (Pd), as the address pointer value of the location which is searched for.

9. The apparatus of claim 7, wherein Ptemp in step (a) is
$$\frac{( T s e t ) * S r}{I d - 1} ,$$
where Tset denotes an input time point calculated in terms of seconds, Sr denotes a scan rate, and Id denotes an interval between I frames.

10. The apparatus of claim 8, wherein Ptemp in step (a) is
$$\frac{( T s e t ) * S r}{I d - 1} ,$$
where Tset denotes an input time point calculated in terms of seconds, Sr denotes a scan rate, and Id denotes the interval between I frames.

11. A method for backward searching for a broadcast signal in a method for searching for the broadcast signal using a storage medium of a TV, the method for backward searching comprising the steps of:
(a) determining whether or not a Direct Move (DM) key is input;
(b) setting a time point to be searched for if the DM key is input;
(c) calculating a distance value (Ptemp) from a current address pointer value (Pnow) corresponding to the time set in step (b);
(d) calculating a difference (Pd) between the current address pointer value (Pnow) and the distance value (Ptemp) calculated in step (c);
(e) comparing the value (Pd) with a minimum value (Pmin) of the address pointers of the storage medium; and
(f) determining the value (Pd) as the address pointer value of a location which is searched for if the comparison result of step (e) indicates that the value (Pd) is equal to or greater than the minimum value (Pmin), and otherwise, determining a value, which is obtained by subtracting the minimum value (Pmin) from the value (Pd) and adding the subtraction result to the maximum value (Pmax) of address pointers of the storage medium plus 1, as the address pointer value of the location which is searched for.

12. A method for forward searching for a broadcast signal in a method for searching for the broadcast signal using a storage medium of a TV, the method for forward searching comprising the steps of:
(a) determining whether or not a Direct Move (DM) key is input;
(b) setting a time point to be searched for if the DM key is input;
(c) calculating a distance value (Ptemp) from a current address pointer value (Pnow) corresponding to the time set in step (b);
(d) calculating a sum (Pd) of the current address pointer value (Pnow) and the distance value (Ptemp) calculated in step (a);
(e) comparing the value (Pd) with a maximum value (Pmax) of the address pointers of the storage medium; and
(f) determining the value (Pd) as the address pointer value of a location which is searched for if the comparison result of step (e) indicates that the value (Pd) is not greater than the maximum value (Pmax), and otherwise, determining a value, which is obtained by subtracting the maximum value (Pmax) of address pointers of the storage medium plus 1 from the value (Pd), as the address pointer value of the location which is searched for.

13. The method of claim 11, wherein Ptemp in step (c) is
$$\frac{( T s e t ) * S r}{I d - 1} ,$$
where Tset denotes an input time point calculated in terms of seconds, Sr denotes a scan rate, and Id denotes an interval between I frames.

14. A processor readable medium for storing a program for performing a method for backward searching for a broadcast signal in a method for searching for the broadcast signal using a storage medium of a TV, the method for backward searching comprising the steps of:
(a) determining whether or not a Direct Move (DM) key is input;
(b) setting a time point to be searched for if the DM key is input;
(c) calculating a distance value (Ptemp) from a current address pointer value (Pnow) corresponding to the time set in step (b);
(d) calculating a difference (Pd) between the current address pointer value (Pnow) and the distance value (Ptemp) calculated in step (c);
(e) comparing the value (Pd) with a minimum value (Pmin) of the address pointers of the storage medium; and
(f) determining the value (Pd) as the address pointer value of a location which is searched for if the comparison result of step (e) indicates that the value (Pd) is equal to or greater than the minimum value (Pmin), and otherwise, determining a value, which is obtained by subtracting the minimum value (Pmin) from the value (Pd) and adding the subtraction result to the maximum value (Pmax) of address pointers of the storage medium plus 1, as the address pointer value of the location which is searched for.

15. A processor readable medium for storing a program for performing a method for forward searching for a broadcast signal in a method for searching for the broadcast signal using a storage medium of a TV, the method for forward searching comprising the steps of:
(a) determining whether or not a Direct Move (DM) key is input;
(b) setting a time point to be searched for if the DM key is input;
(c) calculating a distance value (Ptemp) from a current address pointer value (Pnow) corresponding to the time set in step (b);
(d) calculating a sum (Pd) of the current address pointer value (Pnow) and the distance value (Ptemp) calculated in step (a);
(e) comparing the value (Pd) with a maximum value (Pmax) of the address pointers of the storage medium; and
(f) determining the value (Pd) as the address pointer value of a location which is searched for if the comparison result of step (e) indicates that the value (Pd) is not greater than the maximum value (Pmax), and otherwise, determining a value, which is obtained by subtracting the maximum value (Pmax) of address pointers of the storage medium plus 1 from the value (Pd), as the address pointer value of the location which is searched for.
